(19) United States
(12) Patent Application Publication
(10) Pub. No.: US 2011/0249831 A1
(43) Pub. Date: Oct. 13, 2011

(54) WIRELESS MICROPHONE SYSTEMS HAVING IMPROVED IMMUNITY TO RF INTERFERENCE

(76) Inventor: David C. Bellamy, Simi Valley, CA (US)

(21) Appl. No.: 13/085,813

(22) Filed: Apr. 13, 2011

Related U.S. Application Data
(60) Provisional application No. 61/323,587, filed on Apr. 13, 2010.

(51) Int. Cl. H04B 15/00; H01Q 1/38

(52) U.S. Cl. 381/94.1; 343/895

(57) ABSTRACT

A wireless microphone system is disclosed that uses a multiplicity of antennas to reduce or eliminate effects of radio frequency interference and intermodulation distortion. Signals from the multiplicity of antennas are selectively filtered, amplified and distributed as left and right diversity signals to microphone receivers for audio processing.

### CROSS-REFERENCE TO RELATED APPLICATIONS

This application claims the benefit of U.S. Provisional Application No. 61/323,587, filed Apr. 13, 2010 and entitled Distributed Wireless Microphone Antenna Arrangement (Att. Docket SO8357PR), the entire contents of which are hereby incorporated by reference.

### BACKGROUND OF THE INVENTION

1. Field of the Invention

The present invention relates generally to wireless microphone systems.

2. Description of Related Art

Wireless microphone systems typically include wireless microphone transmitters and wireless microphone receivers with simple antennas. For the majority of simple applications, this configuration provides adequate performance. However, for more demanding applications, particularly in major urban areas with “spectrum congestion” and high ambient radio frequency (RD noise levels, such systems frequently fall short in numerous respects. In all major urban areas, there are literally hundreds if not thousands of active radio and television RF transmitters. All such RF transmitters that operate on frequencies in or near the band of interest, which is generally the 470 to 806 MHz range, can generate both direct interference and unwanted intermodulation products that can destructively interfere with the wireless microphone systems.

Even under idyllic conditions in which experienced wireless microphone users change their frequencies to avoid direct interference from other authorized spectrum users, problems may nevertheless still be experienced. For instance, intermodulation distortion (IMD) can create an even more complex and difficult problem. Indeed, IMD is a widely recognized problem for wireless microphone systems and similar RF communications systems. It arises from the interaction of two or more frequencies in amplifiers when signal levels are high. In the simplest case, frequency “A” interacts with frequency “B” to generate sum and difference frequencies; that is “A” plus “B”, and “A” minus “B”. Most often, such sum and difference frequencies will fall outside of the band of interest and can be ignored. The next type of IMD is known as “third order intermodulation” and consists of the second harmonic of one signal plus and minus the other signal. The sum of the second harmonic of one signal plus the other signal is generally out of band, but the difference is very likely to be within the frequency band of interest where, again, it can interfere with the desired RF In addition, each pair of frequencies will generate two different frequencies, known as intermodulation products, both of which are likely to be within the band of interest.

Other types of IMD exist, and there are related processes that also create unwanted products in a similar manner. Due to the low transmitted power employed by wireless microphone transmitters (most commonly 0.03 to 0.05 watt) and the high sensitivity of the receivers, even very low level IMD products can severely disrupt the audio. In an urban environment there are typically hundreds of transmitters in the frequency range used by wireless microphones, including other wireless transmitters in use at the location where the microphones are use or nearby. Accordingly, the total number of frequency combinations that can create disruptive IMD products can become a nearly insurmountable problem.

RF interference (RFI) is also a common problem with wireless microphone systems. Electronic and electrical equipment often unintentionally radiate RF signals in the form of interference. Both interference at discrete frequencies, commonly due to radiation from computers and other digital devices, and broadband noise, caused by many different types of equipment, are routinely encountered. It is not uncommon for equipment used at events for various purposes, such as artistic presentation, to act as a source of RF interference. A prime example of such interference is the interference generated by now-commonplace video walls. Other examples of such equipment include neon lighting, high power lighting dimmers and various kinds of computers and computer-controlled equipment. Video walls, which generally consist of a large number of flat screen displays, are particular problems at large entertainment events where wireless microphones are used. In some well-documented instances, video walls have made it nearly impossible to use wireless microphone systems at all.

A need thus exists in the prior art for wireless microphones systems capable of operating effectively in the presence of several types of RF inopportune and/or interfering signals. A further need exists for a method of configuring wireless microphone systems to avoid effects of imperfect interfering) RF signals.

### SUMMARY OF THE INVENTION

The present invention addresses these needs by providing, according to a particular embodiment, a wireless microphone system comprising four or more radio frequency antennas configured to receive radio frequency energy from a plurality of wireless microphones. An embodiment of the invention herein disclosed comprises four or more preamplifiers, each preamplifier being configurable to receive radio frequency energy from one of the four or more antennas, each preamplifier comprising an adjustable filter and having adjustable gain and a control module adapted to receive signals from the four or more preamplifiers and to combine the signals into a left diversity signal and a right diversity signal. The embodiment further may comprise at least one radio frequency distribution amplifier adapted to receive as inputs the left and right diversity signals and to generate a plurality of left diversity output signals and a plurality of right diversity output signals according to the received left and right diversity signals.

While the apparatus and method has or will be described for the sake of grammatical fluidity with functional explanations, it is to be expressly understood that the claims, unless indicated otherwise, are not to be construed as limited in any way by the construction of “means” or “steps” limitations, but are to be accorded the full scope of the meaning and equivalents of the definition provided by the claims under the judicial doctrine of equivalents.

Any feature or combination of features described or referenced herein are included within the scope of the present invention provided that the features included in any such combination are not mutually inconsistent as will be apparent from the context, this specification, and the knowledge of one skilled in the art. In addition, any feature or combination of features described or referenced may be specifically excluded from any embodiment of the present invention. For purposes of summarizing the present invention, certain aspects, advantages and novel features of the present invention are described or referenced. Of course, it is to be understood that not necessarily all such aspects, advantages or features will be embodied in any particular implementation of the present invention. Additional advantages and aspects of the present invention are apparent in the following detailed description and claims that follow.

### BRIEF DESCRIPTION OF THE FIGURES

FIG. 1 is a conceptual block diagram of a representative embodiment of a wireless microphone system having four antennas according to the present invention;

FIG. 2 is a perspective block diagram of another embodiment of a wireless microphone system according to the present invention;

FIG. 3 is a pictorial diagram of a partially-shrouded helical radio frequency antenna;

FIG. 4A is a diagram illustrating a method of mounting an antenna of the present invention;

FIG. 4B is a sketch depicting detail of the mounting method of FIG. 4A;

FIG. 5 is a Hock diagram of an exemplary antenna preamplifier configuration for a wireless microphone system according to the present invention;

FIG. 6A is a Hock diagram of a portion of a control module producing a left diversity output;

FIG. 6B is a Hock diagram of another portion of the control module producing aright diversity output;

FIG. 7A depicts a portion of a radio-frequency distribution amplifier that generates a plurality of left diversity outputs; and

FIG. 7B is a block diagram of another portion of the radio-frequency amplifier that generates a plurality of right diversity outputs.

### DETAILED DESCRIPTION OF THE PRESENTLY PREFERRED EMBODIMENTS

Embodiments of the invention are now described and illustrated in the accompanying drawings, instances of which are to be interpreted to be to scale in some implementations while in other implementations, for each instance, not. In certain aspects, use of like or the same reference designators in the drawings and description refers to the same, similar or analogous components and/or elements, while according to other implementations the same use should not. According to certain implementations, use of directional terms, such as, top, bottom, left, right, up, down, over, above, below, beneath, rear, and front, are to be construed literally, while in other implementations the same use should not. The present invention may be practiced in conjunction with various wireless communication systems and other techniques that are conventionally used in the art, and only so much of the commonly practiced process steps are included herein as are necessary to provide an understanding of the present invention. The present invention has applicability in the field wireless devices and processes in general. For illustrative purposes, however, the following description pertains to a Distributed Wireless Microphone Antenna Arrangement (DWMAA) and a related method of operation.

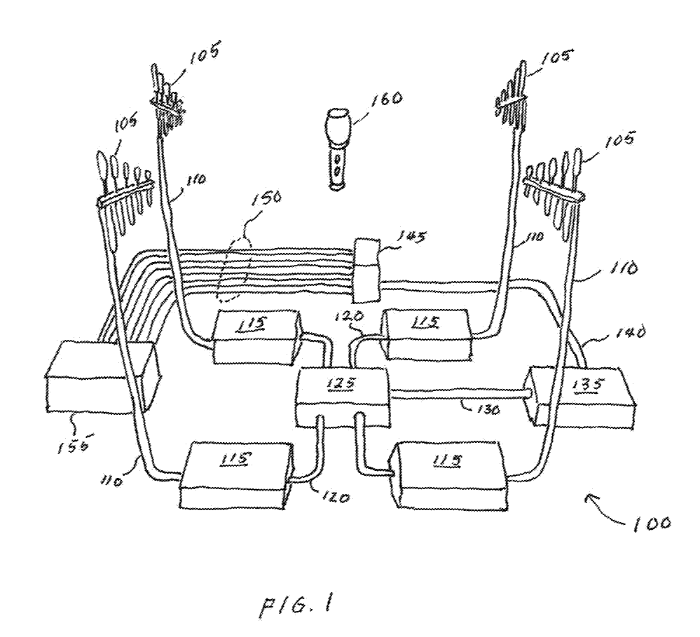

Referring more particularly to the drawings, FIG. 1 is a conceptual block diagram of a representative embodiment of a DWMAA system 100 configured according to the present invention. The embodiment comprises four antennas 105 each of which is connected to a stage-1 filter module 115 by first radio frequency (RF) cabling 110. The four stage-1 filters 115 connect to a control module 125 by second RF cabling 120, and the control module 125 connects to a stage-2 filter 135 by third RF cabling 130. Fourth RF cabling 140 connects the stage-2 filter 135 to a D/A device 145. The D/A connects by means of fifth RF cabling 150 to a plurality of microphone and intercom receivers 155.

In an exemplary mode of operation, one or more performers sing or speak into one or more wireless microphones, e.g., wireless microphone 160, each of which converts the audio of a performer's voice into an electromagnetic RF Ideally, the RF signal from each individual performer's microphone employs a unique band of frequencies that does not overlap or interfere with the band of frequencies used by another performer's microphone. The RF signals radiate from the microphones, and a composite RF signal is detected by the antennas 105. Unfortunately, the antennas 105 also may receive unwanted RF signals from a variety of sources, which may include, local TV signals and RF interference generated by video walls. intermodulation distortion (IMD) may also be present, considering that the transmitted power by a typical microphone may range from about 3 mW to about 50 mW and the receivers 155 (FIG. 1), requiring that the receivers have high sensitivity. Consequently, even very low levels of IMD products can severely disrupt the audio signal. The signal received by the antennas 105 is coupled into stage-1 filters 115 by first RF cabling 110. The stage-1 filters 115 may process the RF signal to remove at least part of any out-of-band RF interference from the signal before passing the signal to the control module 125 through second RF cabling 120. The control module 125 may combine the four RE signals received from the four antennas 105 and may pass the result to a stage-2 filter 135 through third RF cabling 130.

According to an aspect of the present invention, an operator may control settings on the control module 125 in order to enhance the quality of the the received RF coupled to the stage-2 filter 135. As one example, if one of the four antennas 105 receives a large amount of RF interference (as may be determined, for example during set-up or rehearsal), then the signal from that antenna may be attenuated or turned off. The stage-2 filter 135 performs additional signal processing on the composite received RF signal, thereby improving the quality of the signal, and couples the signal to the D/A 145 through fourth RF cabling 140. An output from the D/A 145, finally, is coupled to a plurality of microphone and/or intercom receivers 155. Typically, each of the receivers 155 is matched to one of the microphones (i.e,, each receiver employs a frequency band that is the same as that of the microphone to which the receiver is matched), and receiver outputs take the form of audio signals that can be further processed (e.g., amplified) and coupled to speakers where the voice(s) of the performer(s) is/are heard.

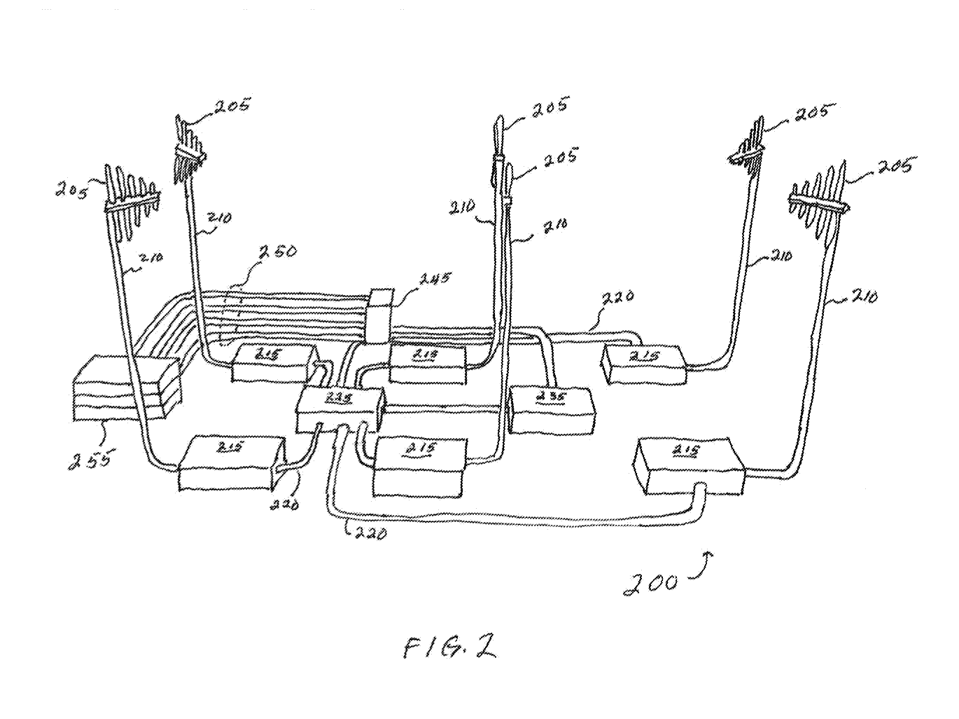

FIG. 2 is a perspective block diagram of another embodiment of a DWMAA system according to the present invention. The illustrated embodiment employs six antennas 205 and, otherwise, functions in a manner similar to that of the embodiment illustrated in FIG. 1. Components in FIG. 2 designated by 2xx correspond in function to similar components in FIG. 1 having reference designators 1xx.

In an exemplary mode of operation, taking the DWMAA system 100 of FIG. 1 as an example, one or more performers sing or speak into one or more wireless microphones, e.g., wireless microphone 160, each of which converts the audio of a performer's voice into an RF signal. Ideally, the RF signal from each individual performer's microphone employs a unique band of frequencies that does not overlap or interfere with the band of frequencies used by another performer's microphone. The RE signals radiate from the microphones, and a composite RF signal is detected b r the antennas 105. As the antennas 105 also may receive unwanted RF signals from a variety of sources that may include, for example, local TV signals and RF interference generated for instance by video walls, intermodulation distortion (IMD) may also be present.

Considering that the transmitted power by a typical microphone may range from about 3 mW to about 50 mW and the receivers 155 (FIG. 1), the problematic situation can be exacerbated by the requirement that the receivers have high sensitivity. Consequently, even very low levels of IMD products can severely disrupt the audio signal. The signal received by the antennas 105 is coupled into stage-1 filters 115 by first RF cabling 110. The stage-1 filters 115 may process the RF signal to remove at least part of any out-of-band RF interference from the signal before passing the signal to the control module 125 through second RF cabling 120. The control module 125 may combine the four RF signals received from the four antennas 105 and may pass the result to a stage-2 filter 135 through third RF cabling 130. According to an aspect of the present invention, an operator may control settings on the control module 125 in order to enhance the quality of the received RF signal coupled to the stage-2 filter 135.

As one example, if one of the four antennas 105 receives a large amount of RF interference (as may be determined, for example during set-up or rehearsal), then the signal from that antenna may be attenuated or turned off. The stage-2 filter 135 performs additional signal processing on the composite received RF signal, thereby improving the quality of the signal, and couples the signal to the D/A 145 through fourth RF cabling 140. An output from the D/A 145, finally, is coupled to a plurality of microphone and/or intercom receivers 155. Typically, each of the receivers 155 is matched to one of the microphones (i.e, each receiver employs a frequency band that is the same as that of the microphone to which the receiver is matched), and receiver outputs take the form of audio signals that can be further processed (e.g., amplified) and coupled to speakers where the voice(s) of the performer(s) is/are heard.

It should be appreciated that performance of the DWMAA embodiments described in FIGS. 1 and 2 may be significantly improved in comparison with that of prior art wireless microphone systems. While some prior art wireless microphone systems employ a single antenna, others implement simple space-diversity technology, a feature of which is to provide two antennas (e.g., a “left” antenna and a “right” antenna) that, typically, are spaced by a distance ranging from a few inches to a few feet. Embodiments of the present invention, in contrast, may comprise multiple “left” and multiple “right” antennas positioned substantial distances apart (e.g., such as ten to fifty feet and, in a particular example, thirty feet) and electronically isolated by amplifiers and active combining circuitry. The level of RF signal, therefore, received by the microphone and intercom receivers 155 may be improved, requiring less gain in the receivers and hence reduced interference and IMD levels.

Unlike prior-art systems with simple diversity antennas, the DWMAA can simultaneously achieve full performance from the wireless receivers and a high degree of interference rejection from wireless microphone transmitters dispersed over a large area. The distributed antenna system allows use of directional antennas to control outside interference and increase the received signal strength, while still providing coverage over a large physical area (e.g., thousands of square feet).

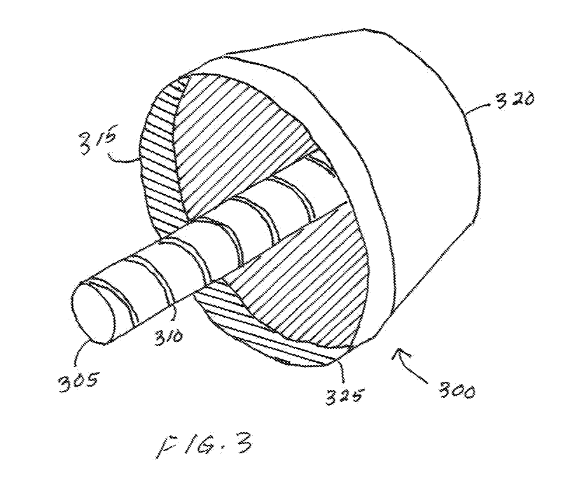

According to an aspect of the invention, highly directional antennas may be employed in order to improve rejection of interfering signals. According to an aspect of the invention, an optimized implementation of the DWMAA requires antennas with specific performance characteristics. These antenna performance characteristics include a combination of three or more (preferably all) of: 1) flat gain over a wide bandwidth, 2) moderate on-axis gain, 3) high rejection of signals arriving from the back of the antenna, and 4) a controlled off-axis response. These requirements are achieved by, for example, a partially-shrouded RF antenna having an arrangement such as shown in FIG. 3. The illustrated antenna embodiment 300 comprises a cardboard support 305 having a diameter of about 3 inches (preferably 3.1125 inches) around which may be wound a conducting ribbon (e.g., copper) 310 having a nominal width of about 0.25 inches. The cardboard support 305 may have a typical length of about 22 inches (preferably 21.31 inches), and about 8.5 turns of the conducting ribbon 310 may be wound thereon. The cardboard support and conducting ribbon may be disposed on an axis of a circular plastic housing 315 having a metal interior. The housing 315 may have a nominally trapezoidal cross-section, corresponding to a smaller diameter 320 of about 11 inches (preferably 11.5 inches) and a larger diameter 325 of about 16 inches. As constructed, a back of the antenna is a flat conductive surface that acts as a reflector. The metal interior of the housing 315 constitutes a conductive shroud that may provide control of an off-axis antenna pattern and reduce proximity effects. An RF-transparent cover may be placed over the front portion of the antenna to provide protection and, also, to improve the appearance of the antenna in an event that the antenna comes into view of, for example, an audience or a TV camera.

The antenna implementation of FIG. 3, while designed to respond to circularly polarized signals, exhibits a uniform gain when receiving linearly polarized signals of arbitrary orientation. This gain is nominally −3 dB compared to a same-direction circularly polarized signal. In contrast, a linearly polarized antenna can suffer a gain loss of up to 25 dB or so when receiving a linearly-polarized signal that is orthogonal to the polarization of the antenna. Wireless microphone transmitters almost always have linearly polarized antennas. However, the actual polarization angle is highly variable and changes with the user's movement and several other environmental factors. The DWMAA's circularly polarized receiving antennas accommodate these changes with minimal impact on performance.

The exemplary partially-shrouded RF antenna 300 of FIG. 3 has a “−3 dB RF bandwidth” extending from about 500 MHz to about 800 MHz, thus covering the wireless microphone system bands of interest for an exemplary application. Mid-band, on-axis gain is nominally 9.7 db (referenced to a matching circularly polarized signal), sufficient to provide an appropriate degree of directivity. The −3 dB beamwidth. is nominally plus and minus 25 degrees at mid-band. The plus and minus 90 degree off-axis gain is about −15 dB, while the reverse direction isolation is about 20 dB. This means that the antenna's effective gain is about 24 dB less at plus and minus 90 degrees than it is directly on axis. Prior art wireless microphone antennas are simple whips, or sometimes Yagi-Uda or log periodic arrays, none of which provides a high degree of off-axis rejection or reduction of proximity effects.

Because antennas must frequently be mounted in less than optimum locations for practical or aesthetic reasons, the 90 degree off-axis response is critical in achieving required antenna directivity despite close proximity of nearby metallic objects. Prior art antennas such as Yagi-Uda and log periodic arrays typically suffer serious pattern distortion under such conditions. The resulting pattern distortion reduces the gain in the desired direction and increases it off-axis, making the system more susceptible to unwanted signals arriving at the antenna from directions other than that to which it is pointed. The partial shroud 315 substantially reduces these effects without adversely affecting other performance parameters.

The reverse isolation and low 90 degree off axis gain also act to reduce or eliminate unwanted interfering signals from outside sources. These factors are considered during the physical mounting of the antennas, in that the antennas may be mounted high above desired reception areas, pointed downwards at an angle, and with the back of the antennas pointed generally towards identified interference sources.

Continuing with the embodiment 100 of the interconnection of typical generalized DWMAA components of FIG. 1 as an example, the illustrated configuration may comprise multiple antennas 105, each with an associated antenna preamplifier 115, a control module 125, one or more antenna distribution amplifiers (active rnulticouplers) 135 and interconnecting RF cabling 110, 120, 130, 140 and 150. All of the DWMAA components are designed to facilitate rapid temporary installation to support event setup, rehearsals and performances within compressed time frames. In particular, each antenna is provided with mounting devices (i.e., of known structure/function, or as specialized mounts) that easily attach to existing structures such as lighting grids, handrails and temporary stages, and which have elevation and azimuth adjustments for the directional antennas. In contrast, prior art antennas are either supplied without mounts or with only basic fixed mounting hardware.

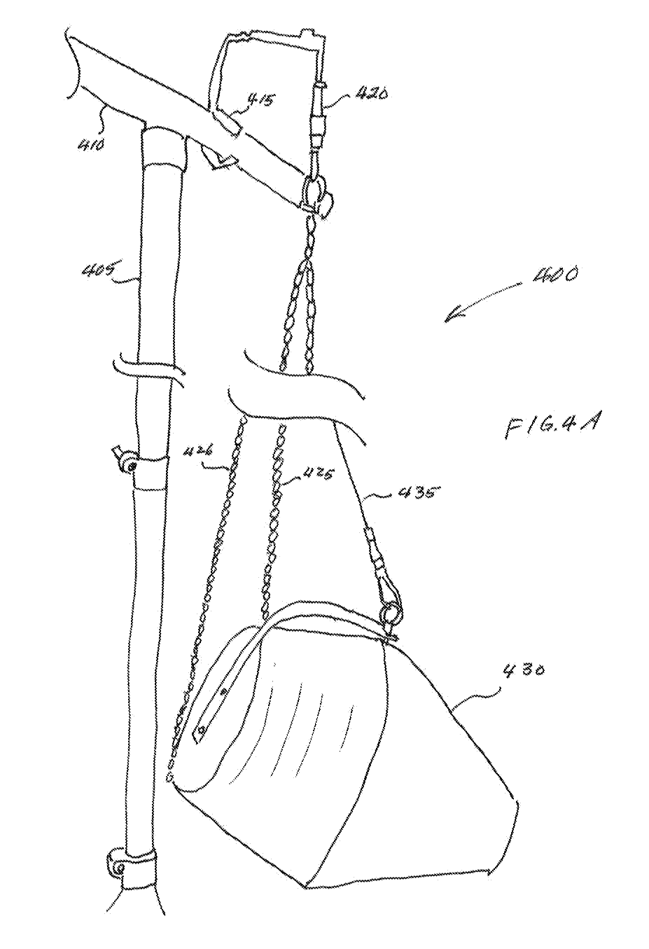

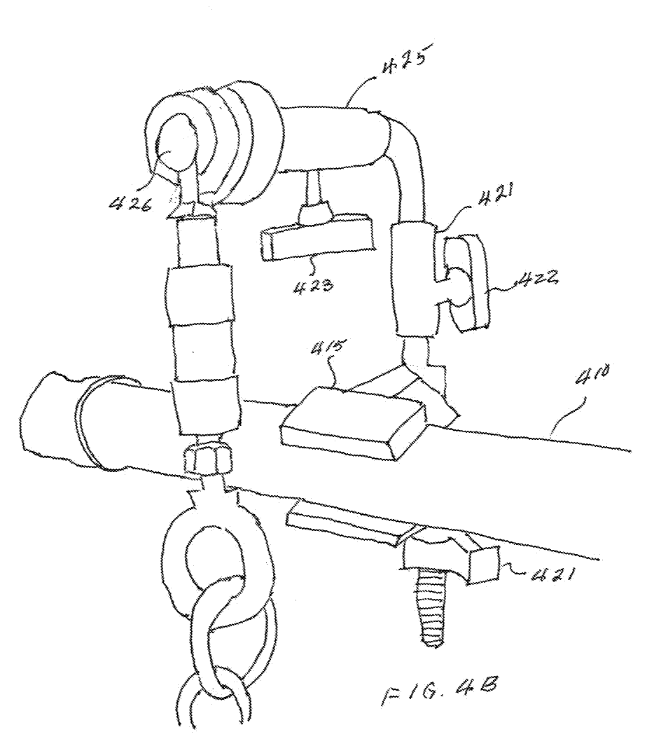

An exemplary mount of the present invention includes hardware to suspend the antenna from existing temporary or permanent structures, an adjustment to vary the azimuth of the antenna and a separate adjustment to vary its elevation angle. FIGS. 4A and 4B show a mount of an implementation of the invention having a structure and function characterized by the adaptability of the mounting method and the provisions to accurately vary a direction in which the antenna points, none of which exist on prior art wireless microphone antenna mounts. FIG. 4A illustrates a mounting pole 405 having a crossbar 410 to which is affixed a clamp 415 connected to a support arm 410 that supports a divided chain 425 and 426 that connect to an antenna in two places. Additionally, a variable-length cable 435 connects to the chain 425 (connection not shown) and to a third location. The pole 405 may be movable and adjustable in height, the clamp 415 may be movable on the crossbar 410, the support arm 420 may be adjustable, and the length of the cable 435 may be adjustable. The adjustability of the structure 400 illustrated in FIG. 4A provides considerable flexibility in tailoring placement and orientation of the antenna 430.

FIG. 413 illustrates in greater detail the support arm portion of the structure 400 of FIG. 4A, in order to illustrate the adjustability of the structure 400. In FIG. 48, a bolt/levered nut assembly allows the clamp 415 to be oriented at any angle at any location along the crossbar 410. Screw handles 422 and 423 and associated sleeves 424 and 425 allow adjustment of the position of a ball joint 426 relative to the clamp 415, These and similar components may be used to rapidly, reliably (e.g., reproducibly) and customizably deploy antennas in accordance with a particular presented situation in order to optimize performance of a particular DWMAA wireless system configuration.

Returning to the configuration of FIG. 2, the illustrated embodiment 200 can comprise several separate units, each containing an assemblage of both off-the-shelf components and/or components especially designed to meet the requirements of the DWMAA, appropriately interconnected. The number of components, their exact configuration and the detailed interconnection may vary by unique application. In the exemplary configuration of FIG. 2, six antennas 205 connect to six preamplifier assemblies 215, which, in turn, connect to a common control module 225. Outputs of the control module feed four diversity antenna distribution units (active multicouplers) 215, supporting 16 or more conventional diversity wireless microphone receivers. It is possible, according to one example, to form much of the system, with the exception of, for instance, the antennas 205, from off-the-shelf components from various sources (packaged appropriately). The antennas 205, not being off-the-shelf, were specifically designed for this application after unsuccessful testing with numerous commercially available (off-the-shelf) antennas, and several prior custom designs. Thus, white the rest of the system of the embodiment may be capable of being assembled from off-the-shelf components from various sources (packaged appropriately), this is not true of the antennas 205. The exemplary embodiment of FIG. 2 is substantially simplified, typical applications often using eight or more antennas 205.

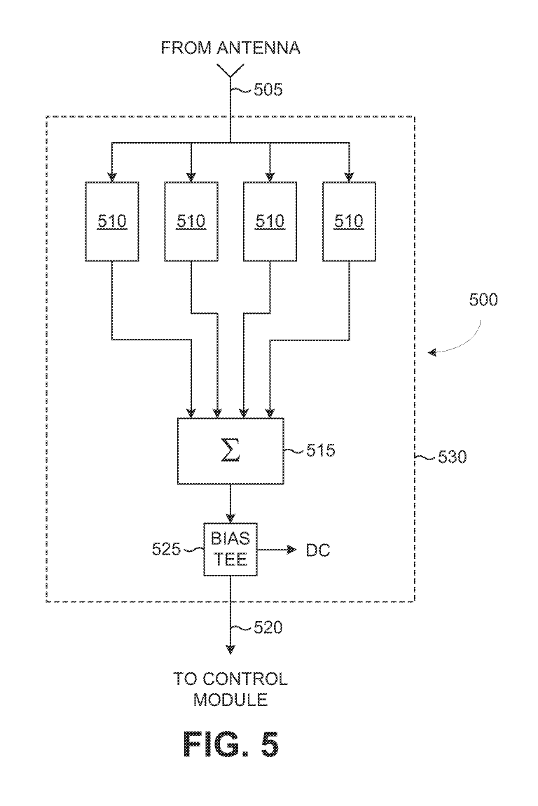

A block diagram of an exemplary antenna preamplifier configuration 500 for use with the DWMAA is illustrated in FIG. 5. Embodiments of a DWMAA system normally include several such units. An antenna preamplifier provides gain to overcome cable loss, as well as band-split filtering to reject undesired RF signals. Filters are used to select and amplify only those frequency ranges (most commonly unoccupied TV channels) in use by the DWMAA to suppress outside interference and reduce IMD. The device has one antenna input 505, a plurality of (e.g., four) independent filter-amplifier units (e.g., channels) 510, a passive combiner (e.g., a four-way combiner) 515 that combines outputs of the filter-amplifier units 510, and one output 520. Power for the circuitry is supplied from a bias tee 525 via an output coaxial cable that connects the preamplifiers to the DWMAA control module. According to one embodiment, the filter-amplifier units 510 comprise four each of Polytron MKK 1206 or MKK 2406 amplifier-filter modules. The embodiment may be encased in a housing 530, which may include the four-way combiner 515 as is the case with, in particular, a Polytron MKK4-4K housing,

The housing 530 may comprise a weather-resistant enclosure suitable for outdoor use if necessary and may include a hinged door to facilitate the gain adjustments that may be performed during system optimization. The unit is connected to its associated antenna via a short length of low loss coaxial cable. This is necessary because the antenna preamplifier must be accessible during system optimization, which often has to be done simultaneously with live rehearsals.

The antenna input is applied to a plurality of (e.g., four) separate tunable filters 510 that form a multi-channel (e.g., four-channel) diplexer. The fitters may be fed in parallel without suffering the inherent loss of a passive splitter due to a high out-of-band. VSWR (voltage standing wave ratio) of the filter inputs. The plurality of fitter amplifier channels 510 each may amplify a different specific frequency range, and each may include a variable gain amplifier. Various amplifier versions may be used, according to a maximum gain thereon. In an exemplary embodiment two versions are used, one with 24 dB maximum gain and one with 12 dB maximum gain. The various versions may have a gain adjustment range of at least 10 dB. Which version is used in a given instance may upon a length of coaxial cable necessary to reach the control module, the higher gain version being used with longer cables.

The filter-amplifiers 510 inherently select and amplify the desired ranges of frequencies by way of, in particular, bandpass filters, and they reject and/or attenuate all other frequencies in an extended band by way of the filter selectivity. This selectivity, which can be set by an operator, is desirable because unwanted signals from interfering RF sources over the entire frequency band often may overload the amplifiers in the system, generating excess noise and lowering the effective system gain. In addition, strong unwanted frequencies can combine with each other or with wireless microphone frequencies in use to generate IMD.

The filters in the filter-amplifier subassemblies 510 are tunable for bandwidths of between about 6 and 20 MHz, and for center frequencies over the entire frequency range covered by the DWMAA, e.g., a range from about 500 MHz to about 800 MHz. In contrast, prior art filter-amplifiers have only one amplifier channel and typically amplify a wide range of frequencies, including many ranges unused by the wireless microphones, and which will likely contain signals that can result in unacceptable IMD.

As already described, the filter-amplifier assemblies 510 may comprise Polytron model MKK1206 or MKK2406 units, which are modular and may be mounted into a Polytron NIKK 4-4K housing. As operational requirements for specific events dictate, various combinations of pre-tuned filter-amplifiers 510 may be mounted into the housing. Less than four filter-amplifiers 510 may be used in some instances. Outputs of the four filter amplifiers are combined in the passive four-way combiner 515 integrated into the Polytron MKK 4-4K housing to provide a single output 520 to connect to the remote DW MAA control module.

The Polytron MKK 4-4K housing includes a bias tee 525. This device extracts DC supply current from the DWMAA control module via the connecting coaxial cable for application to the Polytron filter-amplifiers. The nominal supply voltage is +115 vdc and the current consumption is about 50 milliamperes per amplifier.

During DWMAA setup and optimization, the gain of the Polytron MKK filter-amplifiers may be adjusted to provide a required combination of adequate signal level for selected wireless microphone frequencies, along with maximum feasible rejection of unwanted outside frequencies and locally generated radio frequency interference, The physical packaging of the preamplifier assemblies may he configured to permit ready access to the gain controls on the filter-amplifier modules 510. The antenna preamplifiers 510, and their filters, differ operationally from corresponding elements of the prior art in that the filters are readily tunable and the gain of each filtered channel is separately adjustable.

The antenna preamplifier assemblies may be housed in rugged waterproof cases that can easily be opened for configuration or adjustment. Prior art preamplifiers are not adjustable and are very rarely waterproof or ruggedized. An antenna preamplifier according to a typical embodiment of the invention can comprise a preamplifier, its complementary case with waterproofing and an easy-open structure, and gain adjustment points.

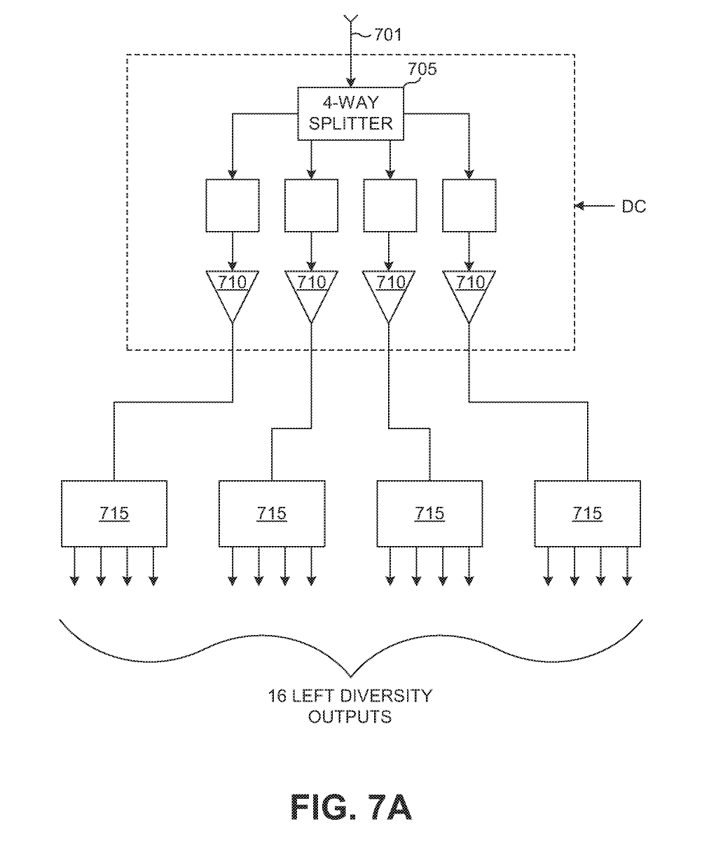

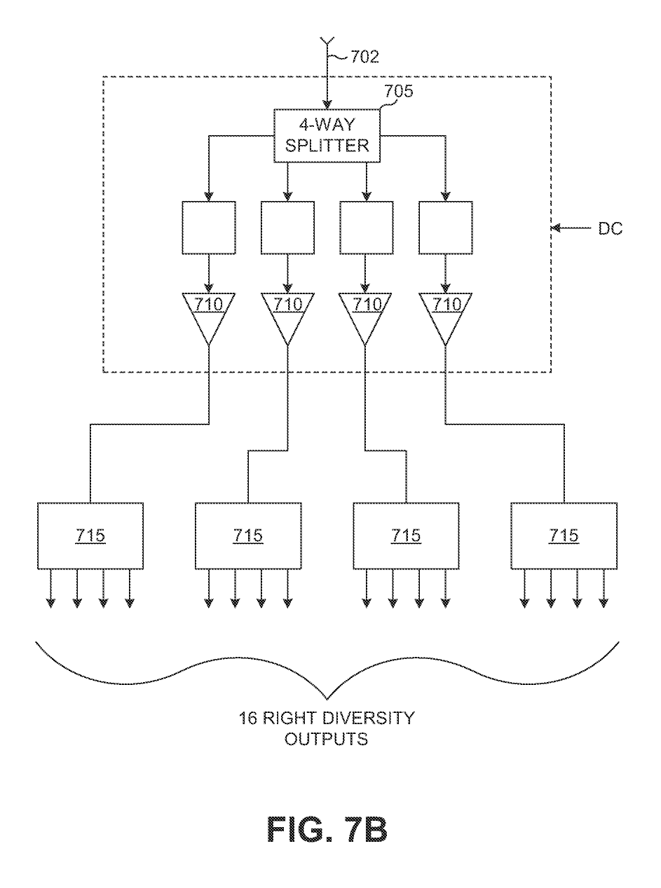

The DWMAA includes one or more control modules e.g. control module 225 (FIG. 2), which serve to interconnect and control antennas, preamplifiers and distribution amplifiers (multicouplers). This component ties together multiple antennas and preamplifiers, provides active isolation and summing, which are necessary to implement a distributed antenna system (i.e., incorporating multiple “left” and “right” antennas). The control module, further, provides for on and off control of individual antennas and preamplifiers, and has diversity outputs to drive multiple distribution amplifiers. Prior art systems have no control module, and have the preamplifier outputs directly driving only one multicoupler. Exemplary embodiments of the DWMAA, on the other hand, are provided with numbers of preamplifier outputs that directly drive corresponding numbers of diversity RF distribution amplifiers (active multicouplers), described below with reference to FIGS. 7A and 7B.

The DWMAA may be specially configured for a particular event, both in quantity of equipment and in tuning and adjustment. This configuring is facilitated by the modular nature of the components, which allow almost unlimited configuration options to meet the unique needs of each event, production or performance. Prior art systems support only groups of two antennas, two preamplifiers and one or more multicouplers in a rigidly defined configuration.

In the DWMAA, the IMD problem is reduced to manageable proportions by filtering that limits the input RF bandwidth to the amplifiers to those specific ranges used by the wireless microphone receivers, which differs from conventional filtering arrangements/functions that use only basic wide-bandwidth RF amplifiers. Strong signals on nearby frequencies that would otherwise create IMD are rejected or attenuated by the fitters in the DWMAA. Prior art systems have a wide RF bandwidth and provide no rejection of unwanted nearby frequencies. Amplifier gain is also carefully controlled in the present invention to that which is necessary for operation of the wireless microphone receivers, further reducing the potential for IMD. Amplifier gain can be controlled by the operator simply opening the preamplifier enclosure and making an adjustment of one or more slotted controls with a small screwdriver. The amplifiers in prior art systems operate at fixed gains, which are often higher than necessary, thereby increasing the potential for IMD due to overload. In typical implementations, the adjustability of DWMAA gains can range from either about 2 to 12 dB, or from 14 to 24 dB, depending upon the amplifier module selected for that particular configuration. Prior art preamplifiers have fixed gains ranging from about 15 to 30 dB.

The DWMAA further incorporates specific devices and components to reduce unwanted intermodulation products and reject both external and local interference. These include antennas with high off-axis rejection, band-splitting via tunable filtering, adjustable gain amplification and RF amplifiers with high intercept points. Prior-art arrangements do not use any specific measures to reduce unwanted intermodulation products beyond that offered by the basic amplifiers in the signal path. Nor do prior-art arrangements use anything to reject external or local interference. At best, a typical prior-art arrangement would rely upon (a) the changing of wireless frequencies to avoid intermodulation products, and (b) the absence of strong external or local RFI sources.

Also incorporated into the DWMAA are specific provisions to control reception on a zone-by-zone basis, this control differing from conventional signal processing (e.g., reception control) arrangements/functions by way of preamplifier on and off control via the control module 225 (FIG. 2). Prior art systems do not have control modules or components with a similar function. The control module 225 allows an operator to change an effective system configuration (e.g., by way of the control switches on the control module), thereby blocking interference originating in one or more specific zone antennas (even as a performance or event is actively in progress) and to deal rapidly with unanticipated problems should they arise. Prior-art arrangements do not allow for rapid toggle switch control of the effective system configuration but rather require connecting or disconnecting RF cables, or making last minute substitutions of the wireless microphone receivers and transmitters.

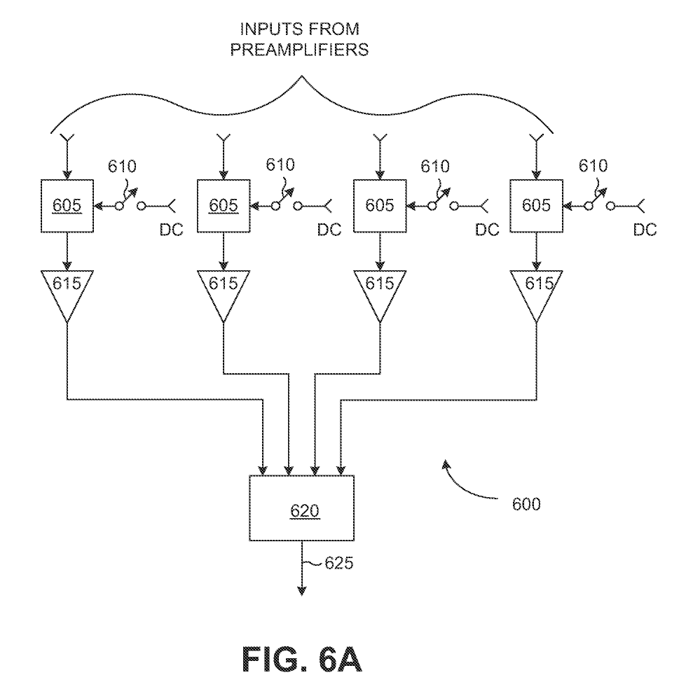

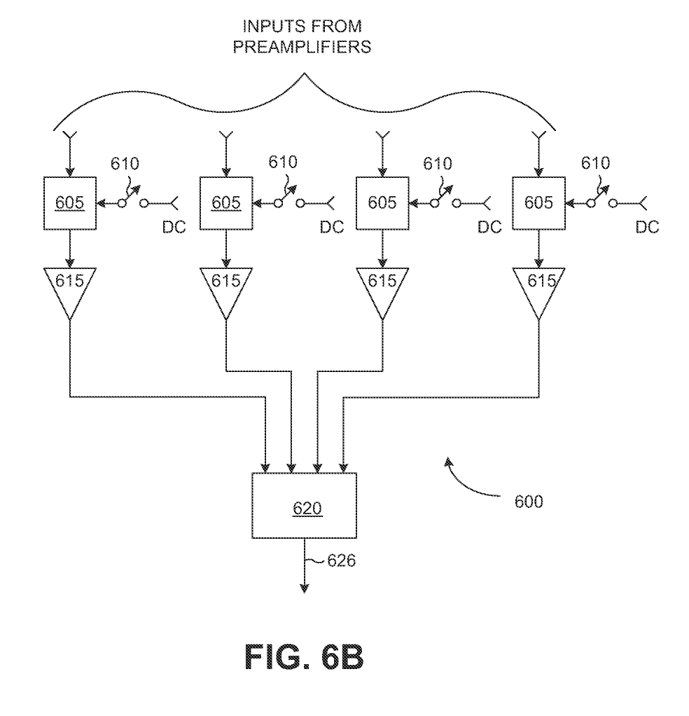

As asserted previously, prior art wireless microphone antennas systems do not have control modules, and consequently, therefore, do not have the capabilities afforded by a control module. According to a feature of the present invention, the control module enables an operator to initiate a relatively wide range of corrective actions if, for example, interference is detected in the audio by the operator during preview of the audio before it goes live on air or to the audience. A block diagram of an exemplary embodiment of a DWMAA. control module is shown in FIGS. 6A and 6B, One embodiment of a control module accepts inputs from several preamplifiers, amplifies these signals and combines them into left and right diversity signals. The number of preamplifier channels is variable with the configuration of individual control modules, and not all channels physically present in a particular control module are necessarily used for a given system.

There are two diversity sets of channels in the control module. All professional wireless microphone receivers have “left” and “right” diversity RF inputs to implement space diversity reception. The left and right designations do not necessarily correspond to any physical relationships in the system. To support the space diversity functionality of the wireless receivers, there are two complete sets of channels in the control module. In a typical implementation, four “left” and four“right” preamplifier channels are supported.

Referring to FIGS. 6A and 613, the control module 600 includes a de power supply (not shown to remotely power the preamplifiers, bias tees 605 to inject the dc onto interconnecting coaxial cables, and control switches 610 to selectively power off individual amplifiers. This capability is a critical system feature in that it allows real-time control of the system configuration in response to events or unexpected problems. The bias tees 605 may be implemented as MiniCircuits model ZFBT-4R2G. The model ZFBT-4R2G device introduces about 0.6 dB of loss while supplying DC currents up to 200 ma, The RF bandwidth extends from below 50 MHz to about 4000 MHz.

In each preamplifier channel, a tow gain, high intercept point RF buffer amplifier 615 is provided following the bias tee 605. The RE buffer amplifiers 615, which my be implemented as MiniCircuits model ZFL-2HAD devices having about 11 dB of gain and a third order intercept point of +33 dBm, are wideband devices and have a −3 dB bandwidth of about 50 MHz to 1000 MHz.

Following the buffer amplifiers 615, a passive RF combiner 620 is provided for the left (FIG. 6A) and right (FIG. 6B) diversity channels. Each RF combiner 620 is a multi-input (e.g., four-input), one output device, implementable as, for example, a MiniCircuits Model ZFSC-4-1-BNC. The RE combiners 620 have a nominal combining loss of about 7 dB, and a bandwidth extending from below 100 MHz to 1000 MHz.

The output of the control module 600 consists of one “left” diversity channel 625 (FIG. 6A) and one “right” diversity channel 626 (FIG. 6B). For many system implementations, eight antennas (four left and four right) and two RE outputs are insufficient to support the required number of wireless microphone receive channels. In this case, multiple control modules and additional antennas and preamplifiers are used. For instance, as just one example, two control modules and up to 16 antennas and preamplifiers may be used.

The control module 600 includes operator switches 610 to turn off individual antenna preamplifiers. This allows the operator to selectively shut down the output of antennas that are picking up unwanted signals, whether external or local. In some instances, at different times during an event, wireless microphone transmitters may be present in an area where full time reception is undesirable. With the control switches, the appropriate antennas can be turned on when needed and turned off when not. In other cases, unwanted and unapproved transmitters or RE sources may be introduced during an event, causing potentially serious problems. With the switch function, the area containing the offending RE source can be deactivated until the problem can be corrected. Prior art systems have no such capabilities, other than to hurriedly identify and disconnect specific RF cables.

Embodiments of the present invention may include RF distribution amplifiers 135 (FIG. 1) also referred to as stage-2 filters. Block diagrams of RF distribution amplifiers 700 are shown in FIGS. 7A and 7B.

Typical implementations of the present invention may be configured to support substantial numbers of diversity wireless microphone receivers. To support this requirement, diversity RF distribution amplifiers (active multicouplers) follow the control module. In the a common implementation of the system, the left and right diversity outputs 625 and 626 of the control module 600 (FIGS. 6A and 6B) are passively split into a first plurality of signals in a first splitter stage, and each of the first plurality of signals is filtered and amplified and then split into a second plurality of signals in a second splitter stage, thereby yielding a third plurality of diversity “left” and “right output signals. In one particular configuration, the left and right diversity outputs 625 and 626 are split four ways in the first splitter stage, filtered and amplified, then again split four ways in the second filter stage. This yields sixteen diversity “right” outputs and sixteen diversity “left” outputs. Additional stages beyond two may be employed in some embodiments.

With reference to FIGS. 7A and 713, left (FIG. 7A) and right (FIG. 7B) diversity inputs, respectively, 701 and 702 are passively split for ways in a splitter 705, which may be implemented as, for example, a Polytron MKK 1-4K housing. The resulting four outputs are then applied to four plug-in filter-amplifiers 710. The outputs of the individual filter-amplifiers are applied to separate four-way passive signal splitters 715, which may be implemented as MiniCircuits Model MC-4-1-13NC signal splitters. The individual filter-amplifiers 710 for each signal path have adjustable bandwidth and variable gain. In this manner, the signals in each filtered band can be adjusted to have the appropriate amount of gain.

The RF distribution may be disposed in a housing, for example, a Polytron MKK 1-4K, which may include up to four MKK1206 or MKK2406 filter amplifier assemblies, The gain for each filtered band may be adjusted by 10 to 12 dB, which in conjunction with the 12 dB gain of the MKK1206 or 24 dB gain of the MKK2406 amplifiers, allows gain settings between about +2 to +24 dB to be achieved. The filters may be adjusted to have bandwidths of between about 6 and 20 MHz, as required by the application.

Following the filter amplifiers, four-way passive splitters, MiniCircuits Model ZFSC-4-1-BNC, are used to provide outputs to drive up to sixteen diversity receiving units. Depending upon the model of the diversity receiving equipment, from one to four receiver channels can be connected to each output of the RF distribution amplifier. the most common implementation, two such receiving channels are supported by each diversity output of the RF distribution amplifiers, providing reception of up to 32 discrete wireless microphone frequencies. Additional antennas, preamplifiers, control modules and RF distribution amplifiers are required when more than 32 wireless frequencies are to be supported, which is contemplated by the present invention.

Corresponding or related structure and methods described in the above-referenced Application No. 61/323,587, are incorporated herein by reference in their entireties, wherein such incorporation includes corresponding or related structure (and modifications thereof) which may be, in whole or in part, (i) operable and/or constructed with, (ii) modified by one skilled in the art to be operable and/or constructed with, and/or (iii) implemented/made/used with or in combination with, any part(s) of the present invention according to this disclosure, that of the application and references cited therein, and the knowledge and judgment of one skilled in the art.

Although the disclosure herein refers to certain illustrated embodiments, it is to be understood that these embodiments have been presented by way of example rather than limitation. The intent accompanying this disclosure is to have such embodiments construed in conjunction with the knowledge of one skilled in the art to cover all modifications, variations, combinations, permutations, omissions, substitutions, alternatives, and equivalents of the embodiments, to the extent not mutually exclusive, as may fall within the spirit and scope of the invention as limited only by the appended claims.

What is claimed is:

1. A wireless microphone system comprising:
four or more radio frequency antennas configured to receive radio frequency energy from a plurality of wireless microphones;
four or more preamplifiers, each preamplifier being configurable to receive radio frequency energy from one of the four or more antennas, each preamplifier comprising an adjustable filter and having adjustable gain;
a control module adapted to receive signals from the four or more preamplifiers and to combine the signals into a left diversity signal and a right diversity signal; and
at least one radio frequency distribution amplifier adapted to receive as inputs the left and right diversity signals and to generate a plurality of left diversity output signals and a plurality of right diversity output signals according to the received left and right diversity signals.

2. The wireless microphone system as set forth in claim I, wherein each of the preamplifiers comprises a plurality of tunable bandpass filters fed in parallel with an output signal from a corresponding antenna, each of the bandpass filters being configured to amplify a different specific frequency range, in order to attenuate frequencies outside the specific frequency range.

3. The wireless microphone system as set forth in claim 2, wherein the bandpass filters are tunable by an operator in order to reject signals from interfering radio frequency sources, thereby reducing noise and intermodulation distortion.

4. The wireless microphone system as set forth in claim 3, wherein the filters are tubable for bandwidths of between about 6 megahertz and 20 megahertz and for center frequencies ranging from about 500 megahertz to about 800 megahertz.

5. The wireless microphone system as set forth in claim 1, wherein the control module comprises:
four or more radio frequency buffer amplifiers configured to receive input signals from the four or more preamplifiers; and
a radio frequency combiner adapted to combine the four or more input signals into the left diversity signal and the right diversity signal.

6. The wireless microphone system as set forth in claim 1, wherein the control module provides for on and off control of individual antennas and preamplifiers.

7. The wireless microphone system as set forth in claim 1, wherein the radio frequency distribution amplifier comprises:
a first splitter stage adapted to split each of the left and right diversity signals into a first plurality of signals;
a filter and amplifier adapted to receive each of the first plurality of signals and to generate corresponding output signals; and
a second splitter stage comprising a first plurality of splitters each configured to split each of the first plurality of signals into a second plurality of signals, thereby generating a third plurality of left and right diversity output signals.

8. A helical antenna comprising:
a circular non-conducting shroud having a metal interior, the shroud having a nominally trapezoidal cross-section with a narrower base and a wider base parallel to the narrower base;
a non-conducting cylindrical support element affixed to the metal interior at a position corresponding to the narrower base of the trapezoidal cross-section; and
a conducting ribbon wound on the support element according to a helical pattern.

9. The helical antenna as set forth in claim 8, wherein:
the narrower base corresponds to a diameter of about 11 inches;
the wider base corresponds to a diameter of about 16 inches;
a length of the support element is about 21 inches;
a diameter of the support element is about three inches; and
the helical pattern comprises about 8.5 turns distributed over the length of the support element.

10. The helical antenna as set forth in claim 8, wherein the antenna responds to circularly polarized signals.

11. The helical antenna as set forth in claim 8, wherein the antenna exhibits a uniform gain when receiving linearly polarized signals of arbitrary orientation, the antenna exhibiting a nominal −3 decibel gain when responding to linearly polarized signals relative to a response to a circularly polarized signal in the same direction.

12. The helical antenna as set forth in claim 8, wherein:
the antenna has a −3 decibel bandwidth extending from about 500 megahertz to about 800 megahertz;
a mid-band on-axis gain of the antenna is nominally 9.7 decibels;
a −3 decibel bandwidth of the antenna is nominally plus and minus 25 degrees at midband;
the antenna exhibits a reverse isolation of about 20 decibels; and
a plus and minus 90-degree off-axis gain of the antenna is about −15 decibels.
